(19) United States
(12) Patent Application Publication
(10) Pub. No.: US 2010/0308598 A1
(43) Pub. Date: Dec. 9, 2010

(54) Gravity-Electricity Generator

(76) Inventor: Samuel Jackson Flakus, Carson City, NV (US)

Correspondence Address: Sam Flakus, 145 Lake Glen Dr., Carson City, NV, 89703, US

(21) Appl. No.: 12/477,920

(22) Filed: Jun. 4, 2009

(51) Int. Cl. H02K 7/18; F03B 13/00; F03B 3/18; F03B 11/00

(52) U.S. Cl. 290/1 A; 60/327; 415/182.1; 415/148; 60/456

(57) ABSTRACT

A device that converts gravitational energy into electricity using the weight of a vehicle with a hydraulic turbine transmission that dissipates the acceleration into the generator while the vehicle drops at a fixed, constant speed, represented by Newton's 2^{nd} Law of Motion; the resulting electrical power generated being used for utility use on the surrounding municipal power grid and the structure, a multiple story parking garage, it operates in. The turbine and generator are combined into one unit; the blades, which variate in pitch according to speed and torque are affixed to the field rotor of the generator, which acts as a flywheel and rotates around the armature rotor, which is rotated in the opposite direction by the fluid pump shaft, generating the electrical power. Hydraulic pressure comes from a fluid pump that is turned by cables with one end attached to a platform, the other end attached to slightly heavier counterweights.

### DESCRIPTION OF THE PREFERRED EMBODIMENT

The following invention, derived from the vivid imagination empowered by the inventor, converts gravitational energy into electricity using the weight of a vehicle with a hydraulically-driven turbine transmission that dissipates the acceleration into the generator while the vehicle drops at a fixed, constant speed, as represented by Newton's 2^{nd} Law of Motion. The resulting electrical power generated being used for utility use on the surrounding municipal power grid and the structure, a multiple story parking garage, it operates in. The turbine and generator are combined into one unit; the blades, which variate in pitch according to speed and torque are affixed to the field rotor of the generator, which acts as a flywheel and rotates around the armature rotor, which rotates in the opposite direction by the fluid pump shaft, generating the electrical power. Hydraulic pressure comes from a fluid pump that is turned by cables with one end attached to a platform, the other end attached to slightly heavier counterweights.

The product, being electricity, is used to provide power to the building it operates in with the surplus going to the main power grid that the building is connected to. It is theoretically designed to be used in a parking garage, either an existing one above ground or one built underground beneath an existing building, depending on the nature of the building and the desired outcome of what is most profitable according to the needs of the owner(s) who want(s) to distribute the power. When the driver of an automobile wants to park his/her car in the designated parking area, they drive onto a waiting platform suspended from cables in order to support the car. A computer controlled by the driver of the automobile operates brakes on the elevator car that controls which floor/sub-floor the car descends to. The method of propulsion of the vehicle is unimportant; the vehicle can be a car, truck, motorcycle, horse, steam car, etc. The cables that suspend the platform on one end and the counterweights on the other are suspended from large sheaves on a shaft that rotate a rotary hydraulic pump that has four cylinders revolving around the crankshaft. The sheaves are turned by the weight of the vehicle, which cancels out the weight of the counterweight. As the vehicle descends, the hydraulic pump forces fluid through a turbine chamber where the vertical movement of the fluid drives a turbine which has blades that variate in pitch in order to balance the increase of turbine speed and the hydrodynamic resistance needed in order for the vehicle to drop at a constant unregulating speed. The turbine is mounted vertically so that its weight can be evenly distributed on the bearings, reducing the amount of maintenance needed.

This relationship is expressed with Newton's 2^{nd} Law of Motion, which states that the increasing speed of a free-falling object relates directly with time. As the turbine speeds up, the blades turn to increase its speed but also to restrict the speed of the descending vehicle. Therefore, the increase of speed is carried out with the turbine, keeping the vehicle at a steady, constant speed. There is no shaft that connects the fluid turbine to the generator. Rather, the blades of the turbine are affixed to what would normally be recognized as the stator of the generator. A conventional generator consists of a stator, the part that doesn't move, and the rotor, the part that is rotated by the shaft. The fluid turbine transmission that is described is different in that it has two rotors; the inner one, which is connected to the hydraulic pump shaft, rotates in the opposite direction of the outer rotor, which sits on the shaft via sealed friction bearings and is turned by the fluid. The result is a powerful, compact, completely sealed generator that is cooled by the surrounding fluid and avoids the mechanical inefficiency derived from the extra two generator bearings that would otherwise be needed. After the hydraulic fluid is passed beyond the generator, it is recirculated through pipes around the outside of the turbine chamber and fed back into the hydraulic pump.

The hydraulic fluid serves the purposes of driving the machinery, lubricating the cylinders and friction bearings, and displacing the heat that comes from the conversion of mechanical energy into electrical energy. Before reaching the hydraulic pump, the fluid will be at a moderately cool temperature. After passing the turbine, it will be very hot. In order to cool the fluid before being circulated back down to the hydraulic pump, its heat is displaced by turning cool water into steam within a boiler that sits atop the generator casing. The resulting steam and/or hot water can be used for any range of tasks within the building such as heating, air conditioning, cleaning, cooking, distillation (for drinking water or brewery purposes) or can even be directed into a steam engine for further power production. This steam can also be directed into a municipal steam main for distribution throughout the area that surrounds the building as a secondary product of the device.

When the driver of the vehicle has reached the floor that he/she wants to descend to (in above-ground buildings, this is the ground level), the brakes stop the downward motion and the vehicle can drive off. The counterweight is now heavier than the platform, and can now free-fall, pulling the platform back to the top, where the next vehicle is waiting. To go to the top of the garage, the vehicle drives up a ramp.

While the platform is coming back up to the top, the momentum of the moving generator enables it to get a running start at the beginning of the next cycle. During this stage, the output is shut off to allow the generator to act as a flywheel without any workload placed on it, in order to have an advantage in producing the most amount of power possible in the next cycle. Because of the momentum of the generator, the next vehicle raises the speed of the generator more than that of the previous vehicle. This relationship allows the generator system to operate at a high rate of RPM so that it can produce an optimal amount of power at peak operating times.

### BACKGROUND OF THE INVENTION

It is well established within common knowledge that the United States, along with modern civilization as a whole, is in danger of destroying itself. Throughout the last century, we as a nation have grown so dependent on the seemingly infinite wealth of heat and combustion derived from coal and oil that we have entrusted our futures in the wasteful lifestyle that pertains to them being necessary for living in our particular society. It is a wealth that is not as enjoyed by the majority of the human race as it is by the elite clan of top profiteers of those industries upon which the blueprint of that lifestyle is placed. The power hungry have sought great comfort in the vast money to be made from “black gold”, and have used their newfound power to get their feet in the door to influence diplomatic and governmental rule. Oil plays a major role in modern transportation, agriculture, industry, electronics, and seemingly infinite other uses, and has grown so precious that it even outweighs coal, the cornerstone of the Industrial Revolution, in order of importance.

For the first time in world history, the inhabitants of the Earth face a discontenting dilemma of whether to choose between the welfare of the landscape and the atmosphere upon which we live or the expansion of industrial progress. Nature and invention have conflicted with each other since the dawn of intellectual thought to the point that this generation may see the collapse of both. Global warming, which has been widely accepted by the scientific community, is on the brink of running beyond our control, and the cost of crude oil has been climbing exponentially, indicating a shortening supply. Our infrastructure systems are built in such a way that makes it nearly impossible to reasonably walk to where we want to go within our towns and cities in order to perform simple tasks such as errands and the journey between work and home, spreading civilizations far into what was once the pristine wilderness. The importance of the automobile goes beyond a convenience; it is a necessity for living.

But beyond what fossil fuels have done to the Earth, we must look at what they have done to social justice and economic equality. The wealth of the developed world is dependent on the actions of elite groups of people who have unleashed their accumulated power to purchase patents from inventors to prevent competition, lobby for laws within governments that rule in their favor, and above all, disregard human rights by waging savage wars that are justified by using fear within the oppressing country to win support. It is testament to the evils of the hunger for power and control, and when an entire way of life is reliant upon those types of people, the people who live by that way of life are subject to outrageous manipulation.

It is imperative to the welfare of a people and an environment that, in the same sense that a representative democracy is run by the consent of the governed, they themselves within small communities are enabled to rely and prosper from the raw materials and commodities that are essential to their survival and prosperity. In a government, there must be a system of checks and balances so as to prevent one branch from becoming more powerful than the other two, and the same applies to the cycle of economics, and thus social well-being.

There is a balance that must be struck between industry and nature, but nature should have the better side of the ledger. Our environment, in all its beauty and splendor, must have the least amount of intrusion for our interests so that it can be preserved indefinitely. The key to changing our ways is not by fighting the flow of money through wishfully thinking legislation; it is by working with it.

In order for a community of people to be able to enact this balance between itself and nature, inventions that allow the common small business owner to capitalize off of the vast market of energy production that is environmentally non-intrusive should be used. The invention as described in this patent application is such a device, for it is intended to use the gravitational pull of the earth to convert the kinetic energy of descending mass into electrical kinetic energy. There is no need to try and allow the prices for certain commodities to climb higher to encourage conservation when we can make ideal, ecologically friendly commodities cheaper.

The ideal result of this device is that as progressively more owners of buildings begin to utilize them, the price of fossil fuels will drop dramatically, because by default, land that was once used for parking lots would be able to be resold to other buyers who can use the space for development. This creates (or recreates) a downtown environment over time that would allow people to walk or take public transportation once their vehicle is parked. Fossil fuel-burning power plants must buy their fuel, therefore, they can never offer a lower price to the municipal power company than that of what private business owners can demand for the power company to buy, because gravity is free. However, it is not free to the driver of the vehicle, for he/she must use precious fuel to drive up to the top of the garage. But because driving shorter distances around the town/city outweighs that of what small amount of fuel is needed to drive up a ramp, the benefit outweighs the disadvantage for he who uses it.

As stated, when there is no space needed for parking lots in an urban area, buildings can be constructed closer together. Businesses have historically done this so that they can get in on the commercial action, and because shipping can be done uniformly with railroads and other transportation synergy. This also creates a downtown cultural and financial center for businesses, shopping, restaurants, parks, etc. When a parking garage can be built beneath an existing building as opposed to buying land for a large parking lot, historic buildings, so vital to the identity of a culture, can be preserved for future generations. However, high real-estate value also contributes to the destruction of historic landmarks, so it should be stressed that integrity must be maintained in the interest of their preservation. People would be driving only as far as the broadest distance that needs to be covered in one's daily errands, but because everything is now centralized, many people would be able to use public transportation such as light rail instead.

This creates thousands of competitors, because the common business owner is now allowed to tap into the huge energy market. What if non-profit organizations such as religious groups, charities, and clubs were able to get all the funding they needed without having to rely solely on donations? What if a building owner was able to use the extra income from the power company to invest in new equipment or to help offset the cost of overhead expenditures needed for his/her business?

Money is a universal tool that has cursed the Earth but can also be used to its advantage. The act of conserving money and expanding markets in a different way is the very thing that may enable us to live in a more sociologically and environmentally friendly manner.

### BRIEF DESCRIPTION OF THE DRAWINGS

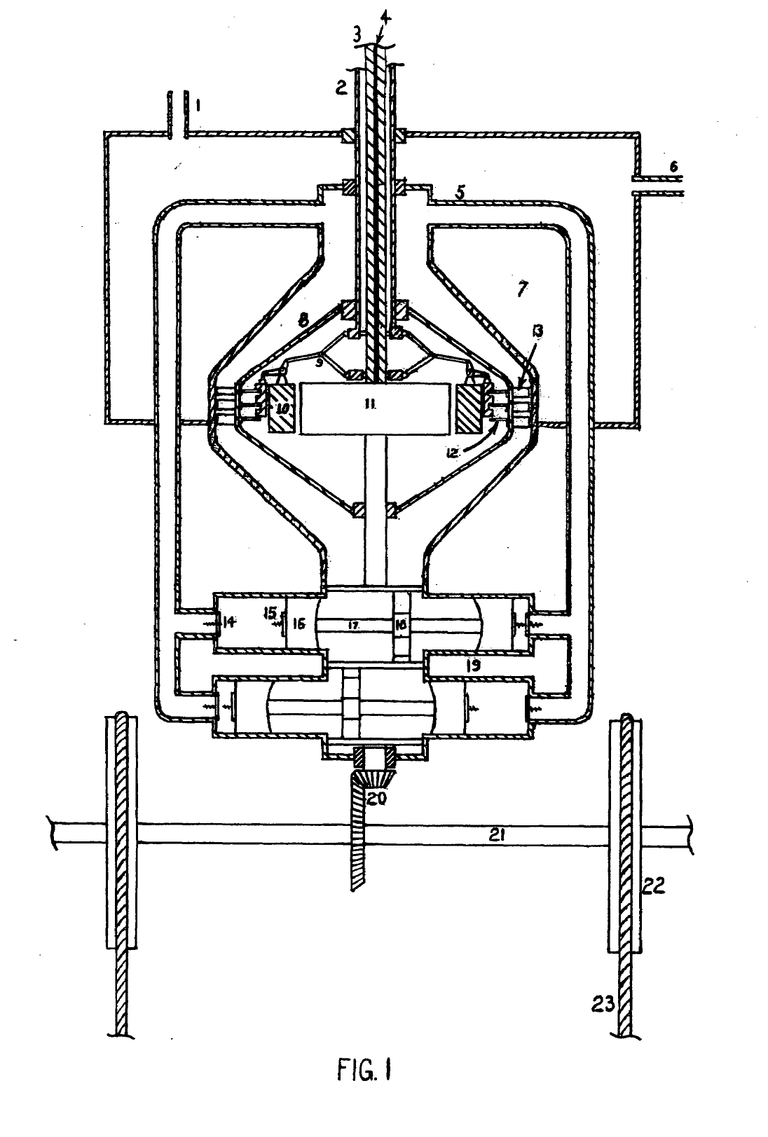

### FIG. 1

Shows interior cutaway view of the inner workings of the device
1. Steam Outlet
2. Blade Pitch Control Shaft
3. Crankshaft
4. Armature Rotor Electrical Contact
5. Fluid Return Pipes
6. Water Inlet
7. Boiler
8. Generator Casing
9. Rotor Linkages
10. Field Rotor Magnets
11. Armature Rotor
12. Blade Pins
13. Turbine Blades
14. Check (One-Way) Valves
15. Check Valves (On Pistons)
16. Pistons
17. Drive Rods
18. Crank Pins
19. Cylinders
20. Pinion Gears
21. Sheaves to Gears Shaft
22. Sheaves
23. Cables

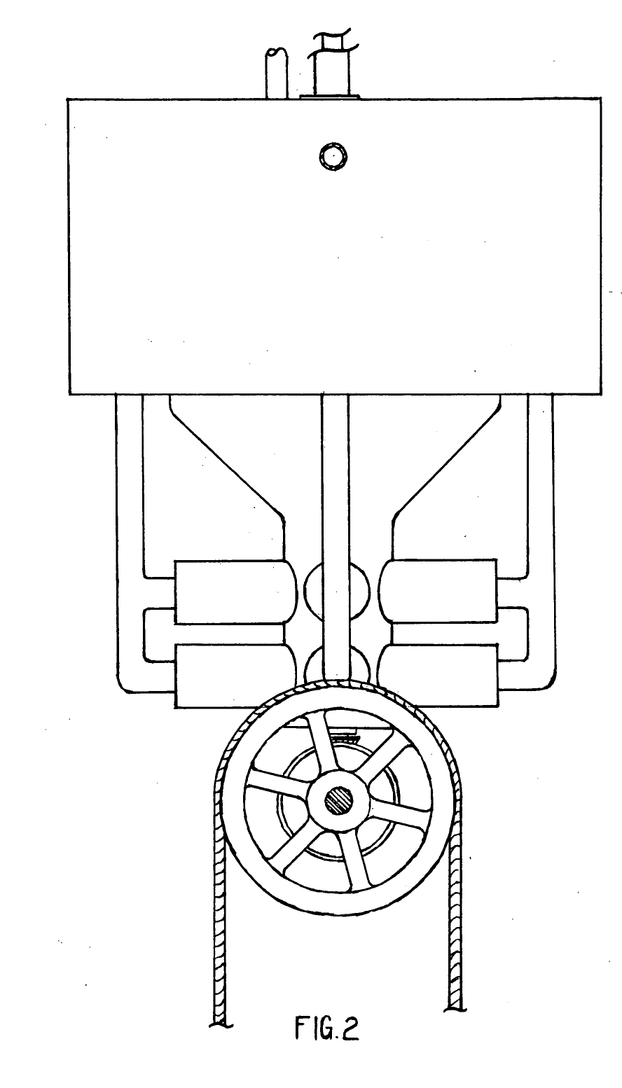

### FIG. 2

Shows the exterior of the device and as rotated clockwise from the top 90 degrees.

What is claimed is:

1. A method of converting the potential energy of gravity into the kinetic energy of electricity using a hydraulic turbine transmission using the power distribution method comprised of the following steps:
the weight of a vehicle being placed upon a platform providing tension on one end of the support cable(s), which are strung around a traction sheave(s) with the other end(s) attached to a counterweight;
the traction sheave(s) providing rotary mechanical energy to a reciprocating hydraulic pump of any gearing ratio;
the now pressurized hydraulic fluid being piped to a turbine/generator unit, transferring fluid energy into rotary mechanical energy which generates the electricity; before sending the fluid back to the hydraulic pump.

2. The turbine/generator unit as referred to in claim 1 being comprised of a one-piece unit with the outer rotor, which provides the electrical field, revolving around the inner rotor, which provides the electrical armature and is connected to the hydraulic pump shaft.

3. The rotor as referred to in claim 2 further comprising of multiple turbine blades that are affixed to the outer radius in order to transfer the upward motion of the pressurized hydraulic fluid into rotary motion of the rotor.

4. The turbine blades as referred to in claim 3 variating in pitch of angle of attack in order to place hydrodynamic resistance on the hydraulic fluid so that the vehicle can descend at a fixed speed and the turbine can thus absorb the gravitational acceleration of the vehicle.

5. The workings of the Gravity Electricity Generator as referred to in claim 1 being controlled by a human commanded electric control system or computer.

6. The electric control system or computer as referred to in claim 5 controlling the brakes of the platform as referred to in claim 1 and the pitch of the turbine blades as referred to in claim 4.

7. The cooling apparatus of the device being a boiler containing water which absorbs the heat of the Gravity-Electricity Generator as referred to in claim 1 by making steam and/or hot water as a secondary product of the device.
